(19) United States
(12) Patent Application Publication
(10) Pub. No.: US 2006/0282682 A1
(43) Pub. Date: Dec. 14, 2006

(54) Control device and electronic apparatus

(75) Inventors: Yasuo Masaki, Osaka (JP); Yasunari Miyake, Osaka (JP); Hideki Tanabe, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/453,308

(22) Filed: Jun. 14, 2006

(30) Foreign Application Priority Data
Jun. 14, 2005 (JP) P2005-173944

(51) Int. Cl. H04K 1/00

(52) U.S. Cl. 713/186

(57) ABSTRACT

A control device includes: an input unit configured to input control information; a transmission unit that transmits the inputted control information to a device to be controlled; an image pickup unit that captures an image of an operator; a face image detection unit that detects a face image from the image of the operator captured by the image pickup unit; and a personal authentication unit that identifies and authenticates the operator according to the face image detected by the face image detection unit, wherein the control device transmits personal information concerning the operator authenticated by the personal authentication unit together with the control information to the device to be controlled.

### BACKGROUND

1. Field

The present invention relates to a control device having an input unit configured to input control information, and a transmission unit configured to transmit the inputted control information, and also relates to an electronic apparatus having the control device.

2. Description of the Related Art

There are many electronic apparatuses, for example, television receivers, air-conditioners, and AV devices, such as video tape recorders and DVD recorders, in recent ordinary homes. Most of such electronic apparatuses are operated by using remote control devices, for convenience thereof.

In a case where, for example, an AV device is used only by an individual, when the condition of the AV device is once set, subsequently, the set condition of the AV device is not frequently changed. Conversely, in a case where, for instance, a television receiver is used by a plurality of users who differ from one another in favorite volume, brightness, and hue, the resetting of the condition of the television receiver may be needed. Also, in a case where an air-conditioner is used by a plurality of users who differ from one another in personal feeling about heat and cold, the set temperature and air-flow of the air conditioner vary with the users.

However, in a case where an electronic apparatus is used by a plurality of users, a related remote control device cannot easily perform an operation of changing set conditions of the electronic apparatus so that the set conditions respectively corresponding to the users differ from one another, and an operation of restoring the condition, which has been once changed, to an initial condition thereof. That is, it is necessary for each user to operate, when the user wishes to cause the remote control device to perform such an operation, the remote control device to thereby set an own favorable condition.

Thus, to solve such a problem, a remote control device with a personal authentication function, which is configured to have a fingerprint authentication function to perform personal authentication on an operator by performing the fingerprint authentication, and to transmit control information, which is suited to the operator, to a device, which is to be controlled, by utilizing a result of the authentication (see, for example, JP-A-2001-045580). This remote control device with the personal authentication is enabled to automatically change a receiving channel to an operator's favorite channel by automatically transmitting information concerning the receiving channel, which is preliminarily set corresponding to the operator in the device according to a result of personal authentication utilizing fingerprint authentication, to a television receiver.

The related remote control device (that is, the remote control device described in the document JP-2001-045580) is configured to perform personal authentication on an operator by utilizing fingerprint authentication, and to transmit the control information, which is suited to the operator, to the device to be controlled. Thus, an operating load imposed on the operator can be alleviated.

However, it is necessary to store all control information, which is used control the device to be controlled, corresponding to personal information on each person in the related remote control device. That is, in a case where this remote control device is used as, for example, a multi-remote-control device, it is necessary to store all pieces of control information on devices, which are to be controlled, by making each of the pieces of control information, which respectively concern all devices to be controlled, correspond to one of different pieces of personal information, which respectively concern operators. Thus, the related remote control device has a problem in that a load imposed on the remote control device is large.

Additionally, the related remote control device utilizes fingerprint authentication for personal authentication. That is, the related remote control device utilizes contact-type personal authentication. Thus, for example, in a case where the remote control device is placed beside the device to be controlled, or where the remote control device is attached to the device to be controlled, it is necessary for using the remote control device that a user goes all the way beside the device, which is to be controlled, that then, the user holds the remote control device in his hand, and that subsequently, fingerprint authentication is performed. In this case, when the personal authentication is of the non-contact type, it is possible to remotely cause the remote control device to perform personal authentication without causing a user to go all the way beside the device to be controlled. That is, it is possible that personal authentication is performed, for example, in a state in which the remote control device remains attached to the device to be controlled, and that control information is transmitted according to a result of the authentication directly to the device to be controlled. In this case, from an operator's standpoint, the device to be controlled is remotely controlled substantially without the remote control device.

### SUMMARY

The present invention provides a control device (or a remote control device) configured so that the non-contact type personal authentication is mounted on the remote control device thereby to seek the possibility of a new usage mode. Also, another object of the invention is to provide an electronic apparatus having this control device.

According to a first aspect, there is provided an electronic apparatus including: a remote control device that includes an input unit configured to input control information and a transmission unit that transmits the control information to the electronic apparatus, wherein the remote control device further includes: an image pickup unit that captures an image of an operator; a face image detection unit that detects a face image from the image captured by the image pickup unit; and a personal authentication unit that identifies and authenticates the operator according to the face image detected by the face image detection unit, wherein the transmission unit transmits personal information concerning the operator authenticated by the personal authentication unit together with the control information to the electronic apparatus, and wherein the electronic apparatus performs a control operation, which is based on the received control information, according to the received control information, the received personal information and control operation data preliminarily set corresponding to the personal information.

According to a second aspect, there is provided a control device including: an input unit configured to input control information; a transmission unit that transmits the inputted control information to a device to be controlled; an image pickup unit that captures an image of an operator; a face image detection unit that detects a face image from the image of the operator captured by the image pickup unit; and a personal authentication unit that identifies and authenticates the operator according to the face image detected by the face image detection unit, wherein the control device transmits personal information concerning the operator authenticated by the personal authentication unit together with the control information to the device to be controlled.

According to a third aspect, there is provided a control device including: an image pickup unit that captures an image of an operator; a face image detection unit that detects a face image from the image of the operator captured by the image pickup unit; a personal authentication unit that identifies and authenticates the operator according to the face image detected by the face image detection unit; and a transmission unit that transmits personal information concerning the operator authenticated by the personal authentication unit together with a control information to the device to be controlled, wherein the control device is configured to be detachable with the device to be controlled, and wherein in a case where the control device is attached to the device to be controlled, presence or absence of the operator is checked by the image pickup unit, the face image detection unit, and the personal authentication unit.

### BRIEF DESCRIPTION OF THE DRAWINGS

In the accompanying drawings:

FIG. 1 is an external view illustrating a remote control device that is a control device according to a first embodiment;

FIG. 2 is a functional block view illustrating the entire configuration of the remote control device according to the first embodiment;

FIG. 3 is a functional block view illustrating the configuration of a primary part of a device to be controlled, which is according to the first embodiment;

FIG. 4 is a functional block view illustrating the entire configuration of a remote control device according to a second embodiment;

FIG. 5 is a functional block view illustrating the configuration of a primary part of a device to be controlled, which is according to the second embodiment; and

FIG. 6 is a functional block view illustrating the entire configuration of a remote control device according to a third embodiment.

### DETAILED DESCRIPTION

Hereinafter, embodiments of the invention are described with reference to the accompanying drawings.

### First Embodiment

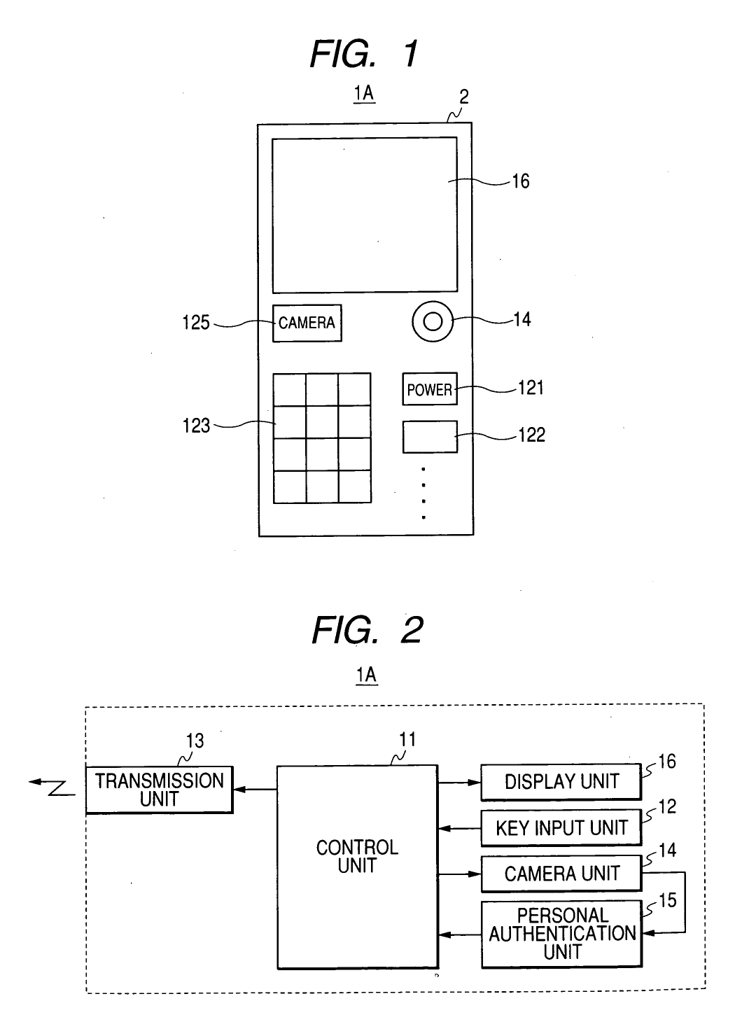

FIG. 1 is an external view of a remote control device 1A, which is a control device according to the first embodiment.

A remote control device 1A according to the embodiment is provided with a display unit 16 including a liquid crystal panel provided at an upper part of a device body 2. Various function buttons are arranged at a lower part of the device body 2. Examples of the function button are a power supply button 121 and a menu button 122. In a case where the remote control device 1A is used for a television receiver, numerical buttons 123 respectively corresponding to numerals 0 to 12.

A camera unit (a CCD camera unit) 14 is disposed in the vicinity of the bottom of the display unit 16. A camera button 125 is disposed beside the camera unit 14. This camera unit 14 is a camera used by an operator to capture an image of the operator himself.

FIG. 2 is a functional block view illustrating the entire configuration of the remote control device 1A according to the first embodiment.

The remote control device 1A according to the embodiment is configured so that a key input unit 12 configured to input control information on a device, which is to be controlled, and a transmission unit 13 configured to transmit the inputted control information to the device to be controlled are connected to a control unit 11 configured to control the entire remote control device. Although not shown, the control unit 11 includes a CPU, a ROM, and a RAM.

Also, the camera unit 14 is connected to the control unit 11. An output of this camera unit 14 is connected to a personal authentication unit 15 configured to detect a face image from the captured image and to authenticate an individual according to the detected face image. A result of the authentication performed by this personal authentication unit 15 is inputted to the control unit 11.

Also, the display unit 16 configured to display the image captured by the camera unit 14 and to display, when the remote control device is operated as a remote control, information on the control information is connected to the control unit 11. That is, the display unit 16 serves to perform both the display of the image, which is captured by the camera unit 14 when the operator is captured, and the display of information on the control information inputted from the key input unit 12 (for example, the display of a menu window),

In the aforementioned configuration, information on physical characteristics of the entire family (in the case of the first embodiment, the characteristics of faces) is preliminarily stored in an internal memory in the personal authentication unit 15. A recognition information registration mode is selected as a storing method by, for instance, operating a menu button 122 of the key input unit 12. The recognition information registration mode is a mode in which an operation of preliminarily storing information on characteristics of an object, which is recognized by the personal authentication unit 15, in a memory unit is performed.

The recognition information registration mode is more specifically described below. For example, in the case of generating recognition data corresponding to a father, he holds the remote control device 1A so that the camera unit 14 is directed toward him. Then, he operates the camera button 25 to thereby capture an image of him. The personal authentication unit 15 generates father recognition data according to the captured face image. An image recognition technique has hitherto been known. Thus, the detail description of the image recognition technique is omitted herein. This father recognition data (or characteristic data) is stored in the internal memory. Subsequently, the personal authentication unit 15 authenticates a specific individual according to the recognition data stored in this internal memory.

Next, an operation, which is performed when the remote control unit is operated by one of the members of the family by using the remote control device 1A, is described below.

When operating the remote control device 1A, the operator directs the camera unit 14 toward his face in a state in which he holds the remote control device 1A in his hand. Then, the operator operates the camera button 125 to thereby set a photographing mode. In response to this operation of the camera button 125, the control unit 11 causes the camera unit 14 to start a photographing operation. Also, the control unit 11 causes the display unit 16 to display an image captured at that time.

Consequently, the operator can capture a face image at the best angle, while watching his face image displayer in the display unit 16.

The personal authentication unit 15 authenticates or identifies the operator by comparing a feature quantity of the face image of the operator, which is captured by the camera unit 14, with a feature quantity of the face image of each of all members of the family. At that time, whether a result of the authentication is correct may be checked by displaying the result of the authentication in the display unit 16. More specifically, a message “ARE YOU SURE THAT OPERATOR IS FATHER?” is displayed in the display unit 16 to cause the operator to check whether the result is correct. In a case where the operator operates an acknowledge button (not shown) displayed in a message window at that time, the control unit 11 stores the result of the authentication (or personal information identifying the operator) in the internal memory.

Thereafter, when an ordinary remote control operation is performed by the operator, the control unit 1 causes the transmission unit 13 to transmit the personal information concerning the operator, which is stored in the internal memory, together with the control information, which is inputted from the key input unit 12 by performing a remote control operation, to the device to be controlled.

It is assumed that this personal information is transmitted only when the control information is transmitted in response to a first remote control operation after the operator is authenticated, and that the personal information is not transmitted at the subsequent transmission of the control information. That is, the personal information is not transmitted until another operator captures an image of his face by operating the camera button 125 and until personal authentication is newly performed. Consequently, when first receiving personal information, the device to be controlled is allowed, until new personal information received by this device, to judge that all the control information, which is transmitted until then, is transmitted in response to an operation performed by the operator identified according to the first received personal information.

FIG. 3 is a functional block view illustrating the configuration of a primary part of a device 2A to be controlled.

The device 2A to be controlled includes a control unit 21 configured to control the entire device 2A, and also includes a reception unit 22, which is configured to receive control information and personal information sent from the remote control device 1A, and a memory unit 24 used to store control operation data corresponding to the control information.

The control unit 21 performs a control operation according to the received control information. For example, in a case where this device 2A to be controlled is an air-conditioner, the control unit 21 adjusts temperature and controls an air volume. Also, in a case where this device 2A to be controlled is a television receiver, the control unit 21 controls the changing of television channels and the adjustment of a sound volume. In this case, when control operation data corresponding to the personal information is not stored in the memory unit 24, the control unit 21 performs only control operations based on the received control information (that is, conventional remote control operations). On the other hand, in a case where control operation data corresponding to the personal information is stored in the memory unit 24, the control operation data in the memory unit 24 is searched by using the received personal information as a key. In a case where there is control operation data corresponding to the same personal information, the control operation data corresponding to the same personal information is read therefrom. Then, control operations represented by the read control operation data are performed.

For example, in a case where the device to be controlled is an air-conditioner, where the operator recognizes, for instance, that the operator is the father, and where it is found as a result of searching the control operation data stored in the memory unit 24 that the control operation data corresponding to the father is stored therein, a temperature control operation is performed according to the control operation data stored therein. More specifically, in a case where the control operation data stored therein indicates that a father's favorite cooling temperature is 23° C. and that a father's favorite air volume is low, an air-conditioning operation (a cooling operation or a heating operation) is automatically started at the set temperature and the set air volume. Consequently, the father, who is the operator, operates only the power supply button 121 after an image of him is captured by the camera unit 14 of the remote control device 1A (that is, after the personal authentication is finished) Thus, the air-conditioner automatically starts an air-conditioning operation at the father's favorite temperature and air-volume. That is, it is unnecessary for the father to perform operations of adjusting the temperature and the air volume by using the remote control device 1A.

### Second Embodiment

Although it is assumed that the remote control device 1A of the first embodiment is operated by an operator himself, a remote control device according to a second embodiment is integral with a device, which is to be controlled, to thereby realize a function of remotely controlling this device in a state in which substantially no remote control device is used from the operator's standpoint.

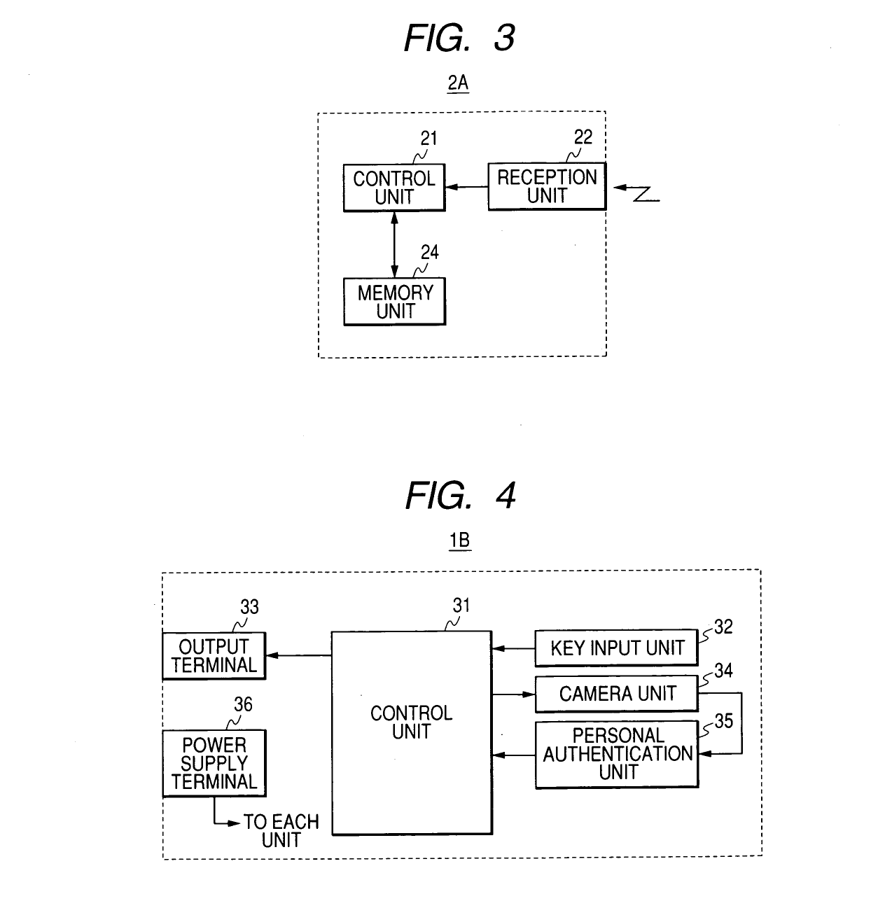

FIG. 4 is a functional block view illustrating the entire configuration of the remote control device 1B according to the second embodiment.

The remote control device 1B according to the second embodiment is configured so that a key input unit 32 configured to input control information on a device, which is to be controlled, an output terminal 33 configured to output the inputted control information to the device to be controlled, and a power supply terminal 36 used to receive electric power supplied from the device to be controlled are connected to a control unit 31 configured to control the entire remote control device. Although not shown, the control unit 31 includes a CPU, a ROM, and a RAM.

Also, a camera unit 34 is connected to the control unit 31. An output of this camera unit 34 is connected to a personal authentication unit 35 configured to detect a face image from the captured image and to authenticate an individual according to the detected face image. A result of the authentication performed by this personal authentication unit 35 s inputted to the control unit 31.

That is, the remote control device 1B according to the second embodiment is configured so that the transmission unit 13 and the display unit 16 provided in the remote control device 1A according to the first embodiment are eliminated, and that the output terminal 33 and the power supply terminal 36 are provided in the remote control device 1B, instead of the transmission unit 13 and the display unit 16.

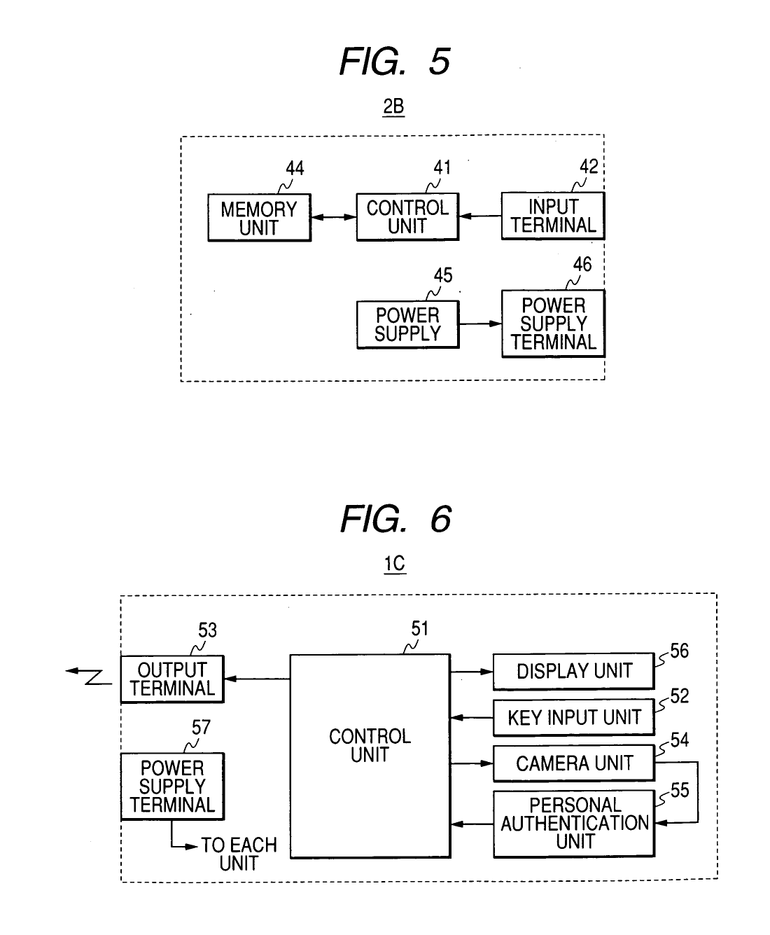

Meanwhile, FIG. 5 is a functional block view illustrating the configuration of a primary part of a device 2B to be controlled.

The device 2B to be controlled includes a control unit 41 configured to control the entire device, an input terminal 42 to which the output terminal n33 of the remote control device 1B is directly connected, a power supply terminal 46 to which the power supply terminal 36 of the remote control device 1B is directly connected, and a memory unit 44 used to store control operation data corresponding to the control information.

That is, the remote control device 1B according to the second embodiment is configured so that the output terminal 33 of the remote control device 1B is connected directly to the input terminal 42 of the device 2B to be controlled, and that the power supply terminal 36 of the remote control device 1B is connected directly to the power supply terminal 46 of the device 2B. Thus, the remote control device 1B can be attached to and formed integrally with the device 2B. After the remote control device 1B is attached to the device 2B, electric power can always be supplied from the device 2B to the remote control device 1B. Consequently, the remote control device 1B can be put into a regular operating state. That is, after the remote control device 1B is attached to the device 2B, the camera unit 34 and the personal authentication unit 35 are made to always operate. Thus, it can be always checked whether an object person of an operation is present in front of the device 2B to be controlled. That is, the presence/absence of the object person can always be checked.

Next, an operation to be performed by each of the remote control device 1B and the device 2B in a case, in which one of members of a family comes in front of the remote control device 1B, is described below.

In a state in which the remote control device 1B is attached to the device 2B to be controlled, the personal authentication unit 35 judges, for example, every 1 or 2 seconds whether a face image can be detected from an image captured by the camera unit 34. Consequently, in a case where no face image is detected, the operation is finished without performing anything. Conversely, in a case where a face image can be detected, a feature quantity of the face image is compared with a feature quantity of each of face images of identified persons, which are stored in the internal memory. Thus, an object person, who is present in front of the device 2B, is authenticated. A result of the authentication (that is, information used to identify the object person) is stored in the internal memory. Subsequently, the control unit 31 inputs the person information concerning the operator, which is stored in the internal memory, to the control unit 41 of the device 2B through the output terminal 33 and the input terminal 42, which are connected directly to each other.

The control unit 41 searches the control operation data stored in the memory unit 24 by using the received personal information as a key. In a case where there is control operation data corresponding to the same personal information, the control operation data corresponding to the same personal information is read therefrom. Then, control operations represented by the read control operation data are performed.

For example, in a case where the device to be controlled is a television receiver, where the operator recognizes from the received personal information that the object person is the father, and where it is found as a result of searching the control operation data stored in the memory unit 24 that the control operation data corresponding to the father is stored therein, a control operation is performed according to the control operation data stored therein. More specifically, in a case where the control operation data stored therein indicates a father's favorite broadcast program and a father's favorite channel, and where a time, at which the personal information is received, coincides with the date and the time, at which the father's favorite broadcast program is broadcasted, the broadcast program is received by automatically changing a current channel to the channel through which the father's favorite program is broadcasted.

Thus, the second embodiment is adapted so that as long as a object person goes in front of (or is present at the front position of) the remote control device 1B attached to the device 2B, the camera unit 34 captures an image of the object person, that the personal authentication unit 35 recognizes an individual and inputs the corresponding personal information to the control unit 41 of the device 2B, and that the device 2B performs a control operation corresponding to the individual. Consequently, the object person can cause the device, which is to be controlled, to perform his desired control operations without performing any operation that the related remote control device does.

That is, according to the second embodiment, the remote control device 1B is united with the device 2B to be controlled. Thus, the device to be controlled is configured to have a face authentication function. Various services corresponding to each of operators can be provided by utilizing a result of face authentication.

Incidentally, the second embodiment is configured so that the transmission unit n13 and the display unit 16 of the first embodiment are eliminated, the remote control device may be configured to have the output terminal 33 and the power supply terminal 36 together with the transmission unit 13 and the display unit 16. In this case, when the remote control device is detached from the device to be controlled, the detached remote control device can be used as the remote control device 1A according to the first embodiment. Consequently, the function of the remote control device 1A and the function of the remote control device 1B can properly be used according to occasions.

### Third Embodiment

Although the second embodiment is configured so that the remote control device 1B is supplied with electric power from the device 2B, which is to be controlled, by attaching the remote control device 1B directly to the device 2B, a third embodiment is configured so that a charging device used to charge the remote control device is separately provided, and that the remote control device is mounted on this charging device, so that electric power is supplied to the remote control device from the charging device.

FIG. 6 is a functional block view illustrating the entire configuration of a remote control device according to the third embodiment.

The remote control device 1C according to the third embodiment is configured so that a key input unit 52 configured to input control information on a device, which is to be controlled, a transmission unit 53 configured to transmit the inputted control information to the device to be controlled, and a power supply terminal 57 mounted on a charging device and configured to receive electric power therefrom are connected to a control unit 51 configured to control the entire remote control device. Although not shown, the control unit 51 includes a CPU, a ROM, and a RAM.

Also, the camera unit 54 is connected to the control unit 51. An output of this camera unit 54 is connected to a personal authentication unit 55 configured to detect a face image from the captured image and to authenticate an individual according to the detected face image. A result of the authentication performed by this personal authentication unit 55 is inputted to the control unit 11.

In the third embodiment, the remote control device 1C mounted on the charging device can be provided at an optional place. Thus, as compared with the case of attaching the remote control device directly to the device to be controlled, the place, at which the remote control device is provided, can freely be determined.

Also, in this case, similarly to the remote control device 1B of the second embodiment, the personal authentication unit 55 judges, for example, every 1 or 2 seconds whether a face image can be detected from an image captured by the camera unit 54. Consequently, in a case where no face image is detected, the operation is finished without performing anything. Conversely, in a case where a face image can be detected, a feature quantity of the face image is compared with a feature quantity of each of face images of identified persons, which are stored in the internal memory. Thus, an object person, who is present in front of the device, is authenticated. A result of the authentication (that is, information used to identify the object person) is transmitted from the transmission unit 53 to the device to be controlled. Incidentally, the configuration of the device to be controlled is the same as that of the device 2A of the first embodiment shown in FIG. 3.

Incidentally, in each of the first to third embodiments, the remote control device has one-to-one relation with the device to be controlled. However, the remote control device may be configured so that information on a person authenticated by the remote control device is multi-scanned to unspecified devices to be controlled. That is, at present ordinary homes, there are a plurality of devices to be controlled, such as television receivers, AV devices, and air-conditioners, serving as the devices to be controlled by using the remote control device. A multi-remote control device, which is adapted so that one remote control device corresponds to a plurality of devices to be controlled, has appeared in such an environment. Various services can be provided to an operator by configuring a remote control device to multi-scan information on an individual authenticated by the remote control device to unspecified devices to be controlled. The remote control device can be applied to such a multi-remote control device.

Although the present invention has been shown and described with reference to the embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. An electronic apparatus comprising:
a remote control device that includes an input unit configured to input control information and a transmission unit that transmits the control information to the electronic apparatus,
wherein the remote control device further includes:
an image pickup unit that captures an image of an operator;
a face image detection unit that detects a face image from the image captured by the image pickup unit; and
a personal authentication unit that identifies and authenticates the operator according to the face image detected by the face image detection unit,
wherein the transmission unit transmits personal information concerning the operator authenticated by the personal authentication unit together with the control information to the electronic apparatus, and
wherein the electronic apparatus performs a control operation, which is based on the received control information, according to the received control information, the received personal information and control operation data preliminarily set corresponding to the personal information.

2. A control device comprising:
an input unit configured to input control information;
a transmission unit that transmits the inputted control information to a device to be controlled;
an image pickup unit that captures an image of an operator;
a face image detection unit that detects a face image from the image of the operator captured by the image pickup unit; and
a personal authentication unit that identifies and authenticates the operator according to the face image detected by the face image detection unit,
wherein the control device transmits personal information concerning the operator authenticated by the personal authentication unit together with the control information to the device to be controlled.

3. The control device according to claim 2, further comprising a display unit that displays the image captured by the image pickup unit.

4. The control device according to claim 3, wherein the display unit performs both of display of the image captured by the image pickup unit and display of information concerning the control information inputted through the input unit.

5. The control device according to claim 2, wherein the control device is configured to be detachable with the device to be controlled, and
wherein in a case where the control device is attached to the device to be controlled, presence or absence of the operator is checked by the image pickup unit, the face image detection unit, and the personal authentication unit.

6. A control device comprising:
an image pickup unit that captures an image of an operator;
a face image detection unit that detects a face image from the image of the operator captured by the image pickup unit;
a personal authentication unit that identifies and authenticates the operator according to the face image detected by the face image detection unit; and
a transmission unit that transmits personal information concerning the operator authenticated by the personal authentication unit together with a control information to the device to be controlled,
wherein the control device is configured to be detachable with the device to be controlled, and
wherein in a case where the control device is attached to the device to be controlled, presence or absence of the operator is checked by the image pickup unit, the face image detection unit, and the personal authentication unit.

7. An electronic apparatus controlled by the control device according to claim 2, characterized in that:
a control operation based on the control information is performed according to the received control information and the received personal information and to control operation data preliminarily set corresponding to the personal information.
